(19) United States
(12) Patent Application Publication
(10) Pub. No.: US 2003/0001977 A1
(43) Pub. Date: Jan. 2, 2003

(54) Apparatus and a method for preventing automated detection of television commercials

(76) Inventor: Xiaoling Wang, Princeton Junction, NJ (US)

Correspondence Address: Mr. Walter J. Tencza Jr., Suite 3, 10 Station Place, Metuchen, NJ, 08840, US

(21) Appl. No.: 09/894,397

(22) Filed: Jun. 28, 2001

(51) Int. Cl. H04N 7/16

(52) U.S. Cl. 348/700

(57) ABSTRACT

An apparatus or system and a method for preventing automated commercial detection is comprised of a commercial transition localization device and a commercial transition modification device. The commercial transition localization device localizes all commercial transitions within a given video signal and supplies the information to the commercial transition modification device. The commercial transition modification device generates a new transition for each found original commercial transition, and replaces the original transitions with the new transitions. The new generated commercial transitions are designed in such a way that they are in general not detectable by automated commercial detection methods used by common commercial detection and elimination systems. For providing sufficient choices for covering a wide range of commercial transition needs, the new transitions may be generated by using the following three types of transition video frames, content-dependent, semi-content-dependent, and content-independent video frames. The system or method can further be enhanced with a feedback loop containing a performance testing procedure that determines if the generated new transitions are actually undetectable by one or more targeted automated commercial detection devices used by common commercial detection and elimination systems.

### FIELD OF THE INVENTION

This invention relates to the field of systems and methods for playing back television programs and commercials.

### BACKGROUND OF THE INVENTION

Television (TV) broadcasters generally have to sell television commercials to support acquisition or creation of regular TV programs. The TV commercials are typically inserted into the regular TV programs and broadcasted at certain time intervals in such a way that television viewers who are interested in watching regular TV programs usually also watch inserted TV commercials.

On the other hand, many viewers of commercially broadcast TV programs wish to view regular TV programs without TV commercials. Therefore, there have been some attempts to provide television viewers with some automatic means for detection and elimination of commercial messages. The automatic means for commercial elimination is typically integrated within a video recording and playback device such as a Video Cassette Recorder (VCR), a Digital Video Recorder (DVR) or a television set. All known prior art in the field of television commercial detection and elimination systems, as described in the U.S. Pat. Nos. 4,319,286 to Hanpachern, 4,750,052 to Poppy and Samelson, 4,752,834 to Koombes, 5,333,091 to Iggulden and McFarland, 5,692,093 to Iggulden at. al, and 5,986,866 also to Iggulden at. al, rely on some sort of automated signal analysis capabilities to detect the commercial messages within regular television program contents. All disclosed methods and systems implement the automated television commercial detection based on the detection of some typical commercial transition frames that are placed between commercials. The typical commercial transition frames may include some low-level signals, such as blank or dark video frames, blank video frames followed by “active scenes”, blank frames followed by another blank frame with a certain timing interval that is typical to commercials, or low audio signals with dark video frames. There is one automated solution available today for television commercial elimination implemented within some of the Video Cassette Recorders (VCR) sold in the US market. The solution, called “Commercial Advance”, is mainly based on the systems and methods disclosed in the following U.S. Pat. Nos. 5,333,091, 5,692,093, 5,986,866, all by Iggulden at. Al. The “Commercial Advance” solution has shown its effectiveness for most television channels and programs. The “Commercial Advance” solution employs two basic steps for commercial detection. In the first step, it uses a video event detector and an audio event detector to detect relevant video events and audio events. The video event detector is mainly based on the detection of black or dark video frames that are frequently observed between commercials. The audio event detector detects generally low audio signals between commercials. By detecting both dark video frames and “silent scene” (low audio signals), “Commercial Advance” method marks the events and store them into an event list that can be analyzed later by its commercial detection method in the second step. The commercial detection method detects multiple groups of commercials based on the event list and a set of rules such as the typical commercial length, minimum number of commercials within each group of commercials.

### SUMMARY OF THE INVENTION

The present invention is designed to provide a system and a method that can effectively render most automated TV commercial detection and elimination methods and systems ineffective that are based on the detection of typical commercial transitions, such as blank or dark video frames.

A system, apparatus, and method according to the present invention can detect and then eliminate typical commercial transition video frames which typically separate TV commercials. Such typical commercial transition video frames also typically separate regular television programs and commercials. The detectable typical commercial transition video frames are replaced with a new or modified commercial transition video frames that are in general undetectable by the common commercial detection systems and methods. At the same time, the modified commercial transition video frames may also need to provide non-intrusive visual effects and smooth transitions between regular programs and commercials as well as between commercials for television viewers.

Additional blank or dark video frames with low audio signal levels can also be inserted into the regular TV program contents in such a way that automated commercial detection systems and methods might misclassify them as typical blank or dark video frames between commercials and therefore eliminate some of the regular TV program contents as commercials for discouraging the implementations and usages of this kind of automated commercial elimination systems in video recording and playback devices and TV sets.

A system, apparatus, and method according to the present invention furthermore provides the possibility for testing the effectiveness of commercially available commercial elimination systems and methods and modifying the parameters of the anticommercial-elimination system accordingly for rendering them ineffective.

### BRIEF DESCRIPTION OF THE DRAWINGS

FIG. 1 is a general block diagram schematic illustrating the overall structure of the first embodiment of the present invention;

FIG. 2 is a general block diagram schematic illustrating the overall structure of the second embodiment of the present invention;

FIG. 3 is a general block diagram schematic illustrating the overall structure of the third embodiment of the present invention;

FIG. 4A is a general block diagram schematic illustrating a content classification device using an automated content classification device;

FIG. 4B is a general block diagram schematic illustrating a content classification device using a manual content classification device;

FIG. 4C is a general block diagram schematic illustrating a content classification device using both automated and manual content classification devices;

FIG. 5 is a general block diagram schematic illustrating a commercial transition modification device of one embodiment of the present invention; and

FIG. 6 is a general block diagram schematic illustrating the overall structure of the fourth embodiment of the present invention; and

FIG. 7 is a general block diagram schematic illustrating the overall structure of the fifth embodiment of the present invention; and

FIG. 8 is a general block diagram schematic illustrating a performance test decision device.

### DETAILED DESCRIPTION OF THE INVENTION

The present invention in one or more embodiments provides a solution that can effectively prevent automated TV commercial detection and elimination that is based on the detection of typical commercial transition frames located between commercials and between a regular content portion and a commercial for separation purpose when a recorded television video or video signal is playing on a video recording and playback device.

The most typical commercial transition frames may include blank video frames and dark video frames. In this invention, we are focusing on the detection and elimination of those typical blank video frames and dark video frames. However, the same concept is also valid for the detection and elimination of other types of commercial transition frames.

All data busses or connections described in the present application, such as by input and output lines can be wired and/or wireless busses or a combination of them. These busses or connections can further be one-way or bidirectional data transferring busses and/or functional and/or logical connections. All devices described in the present application can be implemented with a computer programmed with computer software or may include computer or electronic circuitry which may be programmed through electronics hardware or computer software. All of the devices in various embodiments may actually reside in the same computer such that one computer functions as multiple devices or all of the devices of a particular embodiment. All of the devices in various embodiments may also be implemented with electronic circuitry, processors, static and dynamic memory devices within a system such that they function as multiple devices or all of the devices of a particular embodiment.

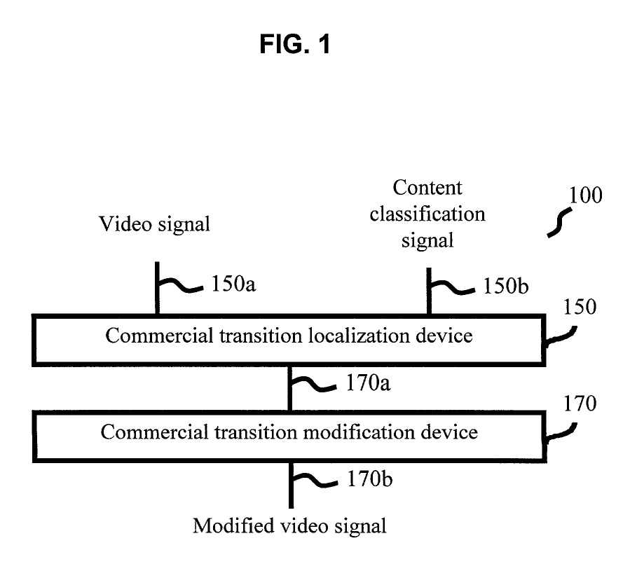

A block diagram of a system, apparatus, and method according to one embodiment of the present invention is shown in FIG. 1. FIG. 1 shows apparatus 100 comprised of a commercial transition localization device 150 and a commercial transition modification device 170. The commercial transition localization device 150 is connected by a bus 170a to commercial transition modification device 170. The commercial transition localization device 150 is connected to a bus 150a and 150b. The commercial transition modification device 170 is connected to a bus 170b.

In operation, referring to FIG. 1, a video signal and its corresponding content classification signal are input via the bus 150a and the bus 150b, respectively, into the commercial transition localization device 150. The video signal may actually be comprised of many video signal portions and the content classification signal may also actually be comprised of many content classification signal portions. Each portion of the video signal may have an associated or related portion of the content classification signal. The content classification signal indicates the locations of all commercials within the video signal. A commercial transition within the video signal is defined as a transition containing a plurality of video frames separating two commercial portions of the video signal or separating a commercial portion from a regular content portion. A commercial group is defined as one or more commercial portions of the video signal within the video signal that are placed and aired together to form a group that can be inserted in between regular or non-commercial TV program contents. A typical commercial group may contain several commercials with a total duration between one and five minutes.

The commercial transition localization device 150 as shown in FIG. 1 at first reads the content classification signal. Based on the provided content classification signal that indicates the locations of all commercials within the video signal, the commercial transition localization device 150 can easily localize the beginning and the end of each commercial portion and hence the commercial transitions that are located between commercial portions. Once the commercial transitions are identified, the video signal and a commercial transition indication signal are supplied to the commercial transition modification device 170 via bus 170a. The commercial transition indication signal may include a plurality of portions. Each portion of the video signal may have an associated portion of the commercial transition indication signal. The commercial transition modification device 170 replaces the identified commercial transition frames within the video signal with a set of modified commercial transition frames that cannot be detected by the commonly used automated commercial detection systems and methods. The device 170 finally outputs a modified video signal on bus 170b. The modified video signal output on bus 170b differs from the video signal input on bus 150a, in that the commercial transition frames in the video signal have been replaced with modified commercial transition frames to form a modified video signal.

The modified commercial transition frames differ from the commercial transition frames. The commercial transition frames for separating for example two commercials by most TV stations today are typically using a “fade” transition effect from a before video scene, such as the last video frame of the first commercial to a dark or blank video scene for producing a disappearing visual effect of the first commercial, and then from the dark or blank video scene to an after video scene, such as the first video scene of the second commercial, for providing an emerging visual effect of the second commercial. Depending on the length of the transition, there may be one or a plurality of dark or blank video frames. If the length of the transition is short, there may be only one or a few dark or blank video frames without any fading video frames or with only a few fading frames. The commonly used automated commercial detection and elimination systems and methods are designed to detect the above-mentioned dark or blank video frames. The modified commercial transition frames differ from the original commercial transition frames essentially in such a way that those targeted and easily detectable dark or blank video frames are replaced with some video frames that are not dark or blank. Since the new replacement video frames are no longer detectable by the automated commercial detection and elimination systems and methods, these systems and methods are no longer capable of detecting the existence of commercial transitions, and hence commercials. The first embodiment in accordance with the present invention can therefore render these automated commercial detection and elimination systems and methods ineffective. Although the effectiveness of the embodiment is only illustrated by detecting and replacing the commonly used easily detectable dark or blank video frames as an example, the embodiment works in principle with any type of detectable transition frames.

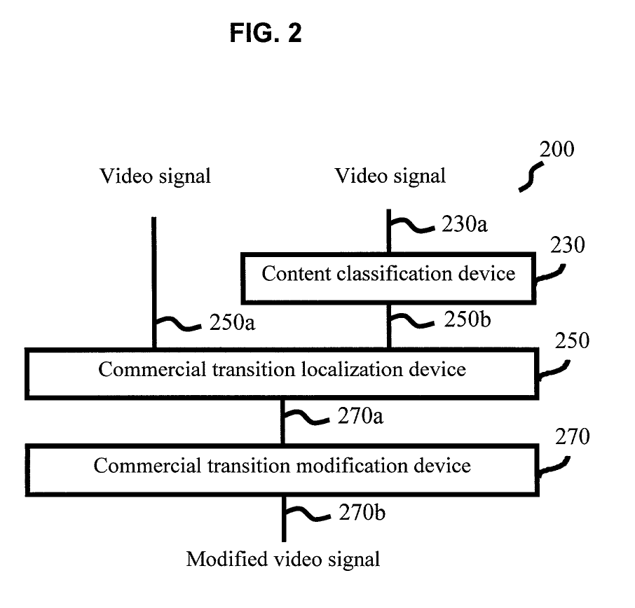

FIG. 2 shows a second embodiment in accordance with the present invention. FIG. 2 shows apparatus 200 that is comprised of a content classification device 230, a commercial transition localization device 250 and a commercial transition modification device 270. Devices 250 and 270 may be similar to devices 150 and 170 of FIG. 1. The content classification device 230 is connected by a bus 250b to the commercial transition localization device 250. Device 230 is also connected to a bus 230a. Device 250 is connected by a bus 270a to device 270. Device 270 is also connected to a bus 270b. Devices 250, and 270 may be connected to one another similarly to devices 150 and 170 of FIG. 1.

The operation of the apparatus 200 of FIG. 2 may be somewhat similar to that of the apparatus 100 of FIG. 1. However, unlike the apparatus 100 of FIG. 1, the commercial transition localization device 250 of FIG. 2 is connected to the content classification device 230 for receiving the content classification signal via bus 250b in accordance with a second embodiment of the present invention. This embodiment is designed for the case when only the video signal is available. Because the content classification signal is not present, it needs to be generated. The content classification device 230 generally classifies a video signal into several defined classes. In the most common case, device 230 classifies a video signal into the following two classes: regular content and commercial. After the content classification, device 230 provides the needed content classification signal to the commercial transition localization device 250 via bus 250b.

In the FIG. 2, embodiment the video signal is applied to both bus 250a and to bus 230a. A content classification signal is generated by device 230 and applied via bus 250b to the device 250. Thereafter the operation of the FIG. 2 embodiment is similar to the operation of the FIG. 1 embodiment. The video signal is supplied on bus 250a as it is supplied on bus 150a and the content classification signal is supplied on bus 250b as it is supplied on bus 150b. The devices 250 and 270 function as the devices 150 and 170 respectively, and a modified video signal is produced on bus 270b as it is on bus 170b.

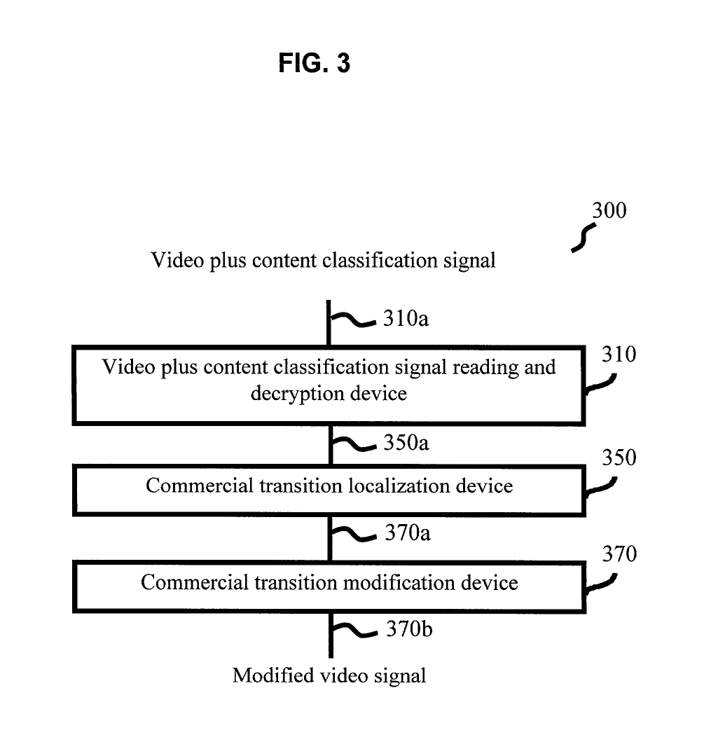

FIG. 3 shows a third embodiment in accordance with the present invention. FIG. 3 shows apparatus 300 that is comprised of a video plus content classification signal reading and decryption device 310, a commercial transition localization device 350 and a commercial transition modification device 370. Devices 350 and 370 may be similar to devices 150 and 170 of FIG. 1. The video plus content classification signal reading and decryption device 310 is connected by a bus 350a to the commercial transition localization device 350. Device 310 also is connected to a bus 310a. Devices 350, and 370 may be connected to one another similarly to devices 150 and 170 of FIG. 1. Device 350 is connected to device 370 bus 370a. Device 370 is also connected to bus 370b.

The operation of the apparatus 300 of FIG. 3 may be somewhat similar to that of the apparatus 100 of FIG. 1. However, unlike the apparatus of FIG. 1, the commercial transition localization device 350 of FIG. 3 extracts a video signal and its corresponding content classification signal from the video plus content classification signal reading and decryption device 310 in accordance with a third embodiment of the present invention. The video plus content classification signal is comprised of a typical video signal and a content classification signal. The video signal may actually be comprised of many video signal portions and the content classification signal may also actually be comprised of many content classification signal portions. Each portion of the video signal may have an associated or related portion of the content classification signal. The video plus content classification signal reading and decryption device 310 determines and extracts the video signal and the content classification signal from the video plus content classification signal and supplies both signals through the bus 350a to the commercial transition localization device 350. Devices 350 and 370 may be similar to device 150 and 170 of FIG. 1. After the content classification signal and the video signal are extracted and supplied to device 350 via bus 350a, the apparatus 300 operates similarly to the first embodiment shown in FIG. 1. A modified video signal is supplied on bus 370b. The modified video signal may be similar to the modified video signal supplied in the FIG. 1 or FIG. 2 embodiment.

A video plus content classification signal described in the previous sections concerning the third embodiment of the present invention can in general take one of the following two basic forms:

(1) The content classification signal can be embedded in the overall video plus content classification signal; or

(2) The content classification signal can be a distinctly separate entity from the video signal in the overall video plus content classification signal.

The first form generally stores content classification information in terms of markings or flags that indicate the beginning and the end locations of all regular content portions (i.e. non-commercial) and commercials within a video plus content classification signal. These markings or flags are easily identifiable and stored within the video plus content classification signal in such a way that the visual and audio part of the original video signal is not modified.

The second form, wherein the content classification signal is a distinctly separate entity within the overall video plus content classification signal is in general more suitable for systems that contain a file reading/writing and management system. The content classification signal may take the form of a content classification description file. A typical content classification description file may be comprised of a file header including but not limited to content owner, content creation date, content modifications, broadcasting related information such as airtime, length of the content, and possibly how many and which commercials as well as their equivalent worth of the “credit points of commercial skips”, along with other needed information, and a file body that exactly describes the content of the video signal in terms of the beginning and the end locations of all regular content sessions and commercials within the video signal. The video plus content classification signal reading and decryption device 310 as shown in FIG. 3, is designed in such a way that the device 310 can read the content classification signal in either form, i.e. embedded or separate and distinct. In the following descriptions of the invention, we will refer to both content classified video forms as video plus content classification signal for convenience.

In order to avoid any unintended access and usage of the content classification information, the video plus content classification signals including both the video signal and the content classification signal can be encrypted in such way that only licensed manufacturers will be able to implement a decryption method in their products and only registered users of those products can get a valid key for decrypting the encrypted video plus content classification signals and/or the content classification signals. The encrypted content classification signals relating to video signals can be embedded within the overall video plus content classification signals or stored distinctly and separately in an encrypted content classification description file associated with the video signal. For preventing any unwanted access to the content classification signal or information for unintended purposes, such as automated commercial skipping, it is sufficient to encrypt just the content classification signal as part of the video plus content classification signal. For an encrypted video plus content classification signal, the video plus content classification signal reading and decryption device 310 may first decrypt the video plus content classification signal before any further processing. If the content classification signal is encrypted in the first embodiment as shown in FIG. 1, a decryption device may be needed. The decryption device may be implemented as a separate device for decrypting the content classification signal and then supplying the decrypted content classification signal to the commercial transition localization device 150 as shown in FIG. 1. The decryption device may also be implemented as an integrated device of the commercial transition detection device. In this case, the commercial transition localization device will decrypt the encrypted content classification signal internally before the localization of commercial transitions based on the decrypted content classification signal.

Since the most commonly used methods and systems for automated commercial detection and elimination are at least partially based on the detection of blank or dark video frames between commercials, the commercial transition localization devices 150, 250, and 350 as shown in FIGS. 1-3 are designed to at least include the capability for detecting blank or dark video frames between commercials.

In order to determine if a commercial transition video frame is blank or dark, there are at least two separate thresholds to be used by the commercial transition localization devices 150, 250, and 350 as shown in FIGS. 1-3. Theoretically, if a video frame is totally blank or dark, the spatial image intensity variation or the average image intensity should be zero, respectively. In reality, due to noises from the transmission channels and the electronics and other influences, the spatial image intensity variation of a blank frame and the average image intensity of a dark frame may not be exactly zero. However, these two values are definitely small in comparison with those values computed from a non-blank and non-dark video frame. Therefore, for detecting a blank frame, its spatial image intensity variation may be computed and then compared with a given threshold. If it is smaller than the threshold value, then the frame is a blank frame. Similarly, for detecting a dark frame, the average image intensity of the frame is computed to see if it is below a given threshold. If it is, then the frame is a dark frame. Once the blank or dark video frames as commercial transition frames are identified by one of the commercial transition localization devices 150, 250, and 350, the blank or dark video frames can easily be modified or replaced by the corresponding commercial transition modification devices 170, 270, or 370 of FIGS. 1-3 to form a modified video signal on the corresponding bus 170b, 270b, or 370b. After the processing, the modified commercial transitions may in general no longer be detected by the automated commercial detection systems and methods that are based on the detection of blank or dark frames between commercials. Some detailed descriptions about detecting blank or dark video frames can be found in the following U.S. Pat. Nos. 5,333,091, 5,692,093, 5,986,866, all by Iggulden at. Al, all of which are incorporated by reference herein.

There are several ways for creating a content classification signal from a video signal by employing automated and manual content classification devices.

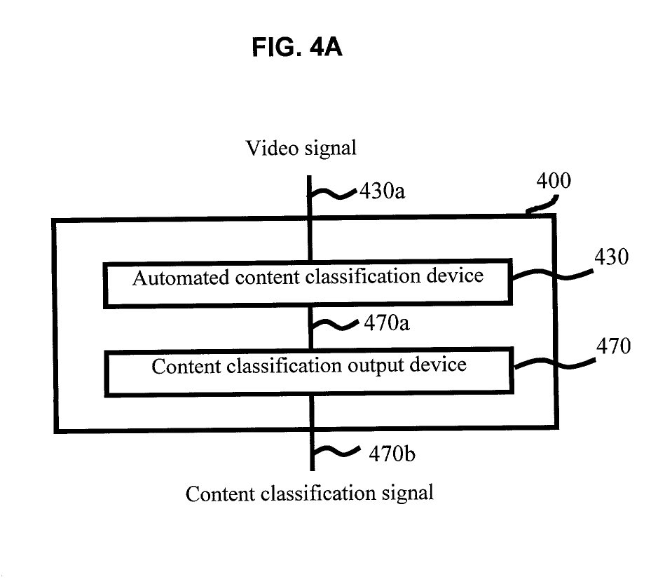

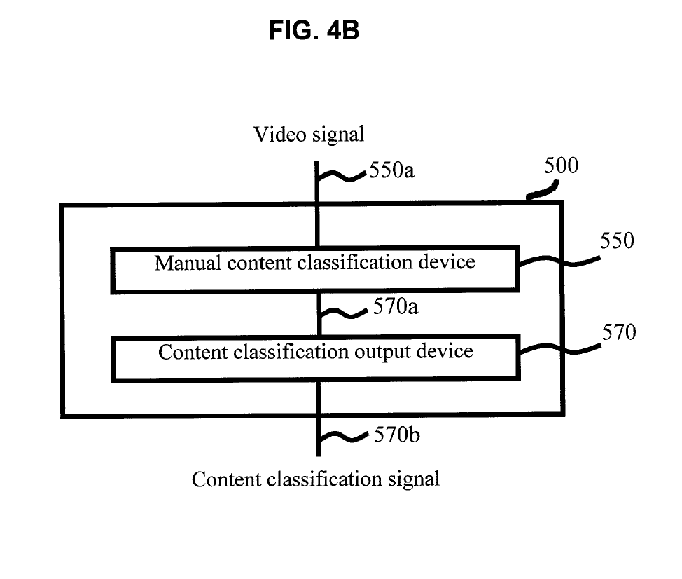

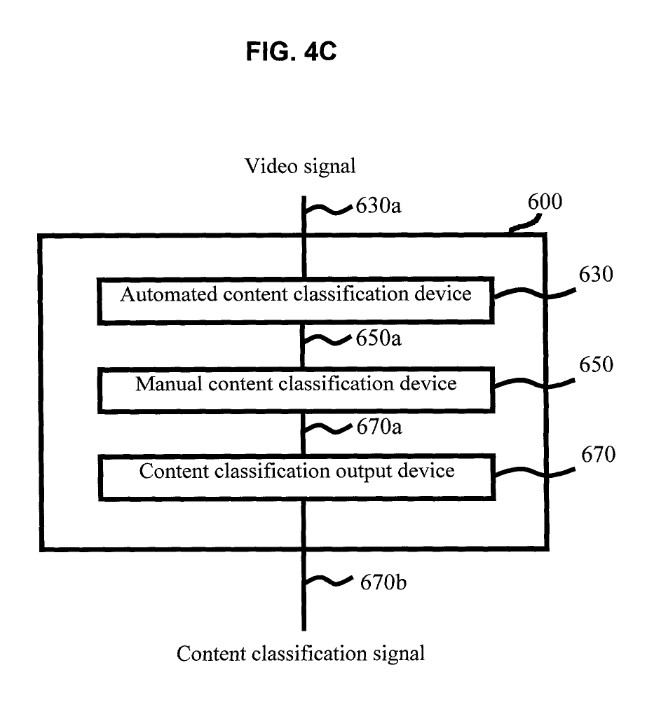

FIG. 4A shows a general block diagram schematic illustrating a content classification device 400, similar to the device 230 shown in FIG. 2 for the creation of a content classification signal from a video signal. The content classification device 400 is comprised of an automated content classification device 430 and a content classification output device 470. The automated content classification device 430 is connected to a bus 430a and is connected to the content classification output device 470 by a bus 470a. The content classification output device 470 is also connected to a bus 470b.

In operation, referring to FIG. 4A, a video signal is supplied through the bus 430a to the automated content classification device 430, which automatically classifies the video content into different classes. In the most common case, device 430 may classify a video signal into the following two typical classes: regular content (non-commercial) portion and commercial portion. The automated content classification device 430 can employ one of the systems and methods as disclosed and described in U.S. Pat. Nos. 5,333,091, 5,692,093, 5,986,866, all by Iggulden at. Al, or a combination of them if needed. These patents are incorporated by reference herein. The automated content classification device 430 supplies the video signal and the content classification signal to the content classification output device 470 via bus 470a. Device 470 outputs the created content classification signal.

As shown in FIG. 4B, the content classification signal can also be created by employing a manual content classification device 550 for classifying commercials within a video signal. FIG. 4B shows an apparatus 500 that includes the manual content classification device 550 and a content classification output device 570. The manual content classification device 550 is connected to a bus 550a and is connected to content classification output device 570 by a bus 570a. The content classification device 570 is connected to a bus 570b.

In operation, referring to FIG. 4B, a video signal is received on bus 550a. The manual content classification device 550 provides a set of functions to be used by one or more human operators for generating the content classification signal from the video signal manually. The content classification signal is then supplied to the content classification output device 570. Device 570 outputs the content classification signal at bus 570b.

The manual content classification device 550 may be a device operated by one or more human operators. The device 550 may be one or more computers with computer software programs that enable operators to use typical computer peripherals devices, such as keyboard, mouse, joysticks or electronic pen input device, to enter content classification information. Typically, human operators view the video signal to determine if the currently playing content belongs to regular content or commercial. If a commercial has been detected, the operators will use the computer peripheral devices to stop the playing video and rewind it to the exact beginning position of the commercial and enter the classification information. The computer software will record the exact position as well as the entered classification information. After the operators have viewed the whole video signal, the complete content classification signal about the video signal can be generated. Because human operators can in general better detect all kinds of commercials, the manual content classification device 550 of FIG. 4B as described above has a higher classification accuracy but much slower classification output than the automated content classification device 430 of FIG. 4A.

For increasing the content classification efficiency, a combination of both automated and manual classification devices can be used, as shown in FIG. 4C. FIG. 4C shows apparatus 600 that includes an automated content classification device 630, a manual content classification device 650, and a content classification output device 670. The automated content classification device 630 is connected to a bus 630a and is connected to the manual content classification device 650 by a bus 650a. The manual content classification device 650 is connected by a bus 670a to the content classification output and encryption device 670. The content classification device 670 is connected to a bus 670b.

In operation, referring to FIG. 4C a video signal is received on bus 630a. The automated content classification device 630 creates an interim content classification signal automatically and passes the video signal and the interim content classification signal to the manual content classification device 650 via bus 650a. The manual content classification device 650 reviews and modifies the interim content classification signal and provides a content classification signal on bus 670a to the content classification output device 670 which outputs the content classification signal on bus 670b.

With the configuration of FIG. 4C, the automated content classification device 630 will first provide automated classification results in the form of an interim content classification signal on bus 650a. The manual content classification device 650 can use the automated classification results on bus 650a as a starting point and only spend time to do needed refinements and modifications where the interim content classification signal from the automated content classification device 630 is not accurate. By doing so, accuracy of the content classification can be improved with relatively low manual classification cost because human operators do not need to review the whole video signal.

A video plus content classification signal can also be created and provided by the content owner or the content broker or the broadcaster of a TV program. Since the content owner or the content broker or the broadcaster may be responsible for editing a TV program by inserting commercials for broadcasting, they have in general concrete knowledge about the regular program content and the inserted commercials. In this case, automated and manual content classification devices may not be necessary. In contrast, an editing tool may be useful.

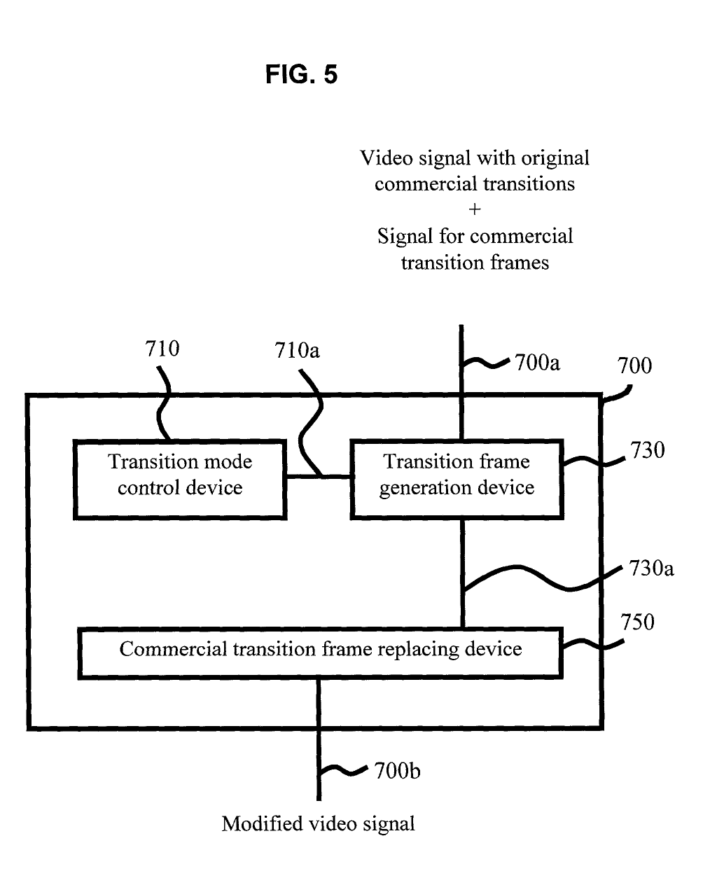

FIG. 5 shows a commercial transition modification device 700. The commercial transition modification device 700, which may be similar to the devices 170, 270 and 370 in FIGS. 1-3, is comprised of a transition mode control device 710, transition frame generation device 730, and a commercial transition frame replacing device 750. The transition mode control device 710 is connected to the transition frame generation device 730 by a bus 710a. Device 730 is also connected to a bus 700a. Device 730 is also connected to commercial transition frame replacing device 750 by a bus 730a. Device 750 is also connected to a bus 700b.

The transition mode control device 710 stores a set of transition mode control data and parameters. The device 710 also supplies the set of transition mode control data and parameters to the transition frame generation device 730 for generating the modified transition frames. The set of transition mode control data and parameters may include but is not limited to:

(a) a transition mode identification parameter that determines which transition mode should be used for generating modified transition frames by the transition frame generation device 730;

(b) a set of parameters associated with each transition mode; and

(c) content data, such as images, graphics, logos, or very short video clips to be used as transition frames.

Since there are many commonly used video transition effects that can be used by the present invention, a transition mode identification parameter is useful for selecting a suitable transition mode from a plural number of transition modes that can be used by the transition frame generation device 730. In addition, each transition mode may require a set of mode-specific control parameters. Therefore, the transition mode control device 710 may also provide a set of parameters associated with each transition mode to the transition frame generation device 730 via bus 710a. Furthermore, the transition frames may also use some content data for generating modified transition frames. For example, one television station may decide to embed its own logo into all modified transition frames separating commercials. In this case, the transition mode control device 710 may also provide the logo data to be used by the transition frame generation device 730 for generating the desired modified transition frames with the logo. Similarly, another TV-station may want to use some special designs in its commercial transition frames. The transition mode control device 710 may also provide the special design data to be used by the transition frame generation device 730 for generating the desired modified transition frames with the special designs.

There are in general three main types of transition frames: content-dependent, semi-content-dependent, and content-independent transition video frames.

The content-dependent transition modified video frames are generated by employing some standard image morphing and transition effect techniques using the video frames that are not blank or dark and located immediately before and after a commercial transition. The content-dependent modified transition video frames offer a visual transition from the “before” to the “after” video scene, where the “before” and the “after” video scene is referred to as, for example, the last non-blank and non-dark video frame located immediately before and the first non-blank and non-dark video frame located immediately after the commercial transition, respectively. Many transition effects may be used for generating the modified transition frames. One simple transition effect implementation with N transition frames T(n) from video frame A to B may be described by the following equation:

T(n)=C(n)*A+(1−C(n))*B,

where n=1, . . . ,N, and C(n)=−n/(N−1)+N/(N−1)

The above equation describes that the transition frame T(n) at frame number n is a linear combination of video frame A and B, with C(n) serving as a coefficient function that decreases linearly with the frame number n. With C(1)=1 and C(N)=0, we have T(1)=A for the first modified transition frame and T(N)=B for the last modified transition frame, respectively. For any transition frame number between 1 and N, we have a combined video frame containing intensity from both video frame A and B. If we denote A and B as the “before” to the “after” video scene, respectively, then the transition frame T(n) provides a reasonably smooth transition from the “before” to the “after” video scene. This transition effect is also known as fade. The “fade” transitions are pixel-by-pixel blends between the “before” video scene and the “after” video scene. The “fade” transitions may also be used to blend between a video scene and a blank or dark video scene.

There are many other transition effects that are based on gradually changing spatial compositions to create transition frames such as “slides” and “pushes” from a “before” to an “after” video scene. The “push” transitions for example look as if the “after” video scene “pushes” the “before” video scene away. In other words, both the “before” and the “after” video scene are moving. In the “slide” transitions, the “after” video scene moves, but the “before” video scene does not. The visual effect of “slide” transitions is that the “after” video scene is “sliding” in across the “before” video scene. Each transition mode may have several sub-modes. For example, a “push” or a “slide” transition mode may have several sub-modes that are characterized by starting from different locations, such as from left, right, top, bottom, or even one of the four corners of a video frame. The speed of the “push” and “slide” transition may also be set differently for creating different effects. Therefore, for a given transition mode, a set of parameters may be needed to control for example the speed and sub-modes. For preserving the content length, the number of the generated content-dependent transition video frames for each transition may be equal to the number of the video frames in each original commercial transition.

The semi-content-dependent modified transition video frames are generated by employing some standard image morphing and transition effect techniques using the video frames that are not blank or dark and located immediately before and after a commercial transition. The semi-content-dependent modified transition video frames offer a visual transition from the “before” video scene through at least one to the “after” scene. The foreign video scene is in general not related to the “before” or “after” scene and is not blank or dark. A foreign video scene may for example be one or more video frames containing one or more patterns, or one or more images with a company logo, or a special graphical design, or a short video clip, or a short animated scene. All of the above-mentioned transition effects, such as fades, wipes and pushes, can be used to create the semi-content-dependent transition modified video frames. The only difference is that the transition in this case will not be made directly from a “before” to an “after” video scene, rather from the “before” over at least one “foreign” video scene and then to the “after” video scene. For preserving the content length, the number of the generated semi-content-dependent transition video frames for each transition may be equal to the number of the video frames in each original commercial transition.

The content-independent modified transition video frames are in general independent to the video frames located immediately before and after a commercial transition. Like the foreign video scene, the content-independent modified transition video frames may be one or more video frames containing one or more patterns, or one or more images with a company logo, or a special graphical design, or a short video clip, or a short animated scene. For preserving the content length, the number of the generated content-independent modified transition video frames for each transition may be equal to the number of the video frames in each original commercial transition.

After the modified transition frames have been generated by the transition frame generation device 730, they will be supplied together with the video signal and the signal for commercial transition frames (indicating the location of the commercial transition frames to be replaced) to the commercial transition frame replacing device 750 via bus 730a. The commercial transition frame replacing device 750 replaces the original commercial transition frames in the video signal with modified commercial transition frames generated by the transition frame generation device 730 to form the modified video signal, and then outputs the modified video signal at bus 700b. Because these modified commercial transition frames are in general no longer detectible by commonly used commercial detection and elimination systems and methods, the commercials within the modified video signal can no longer be detected and therefore the commercials cannot be eliminated.

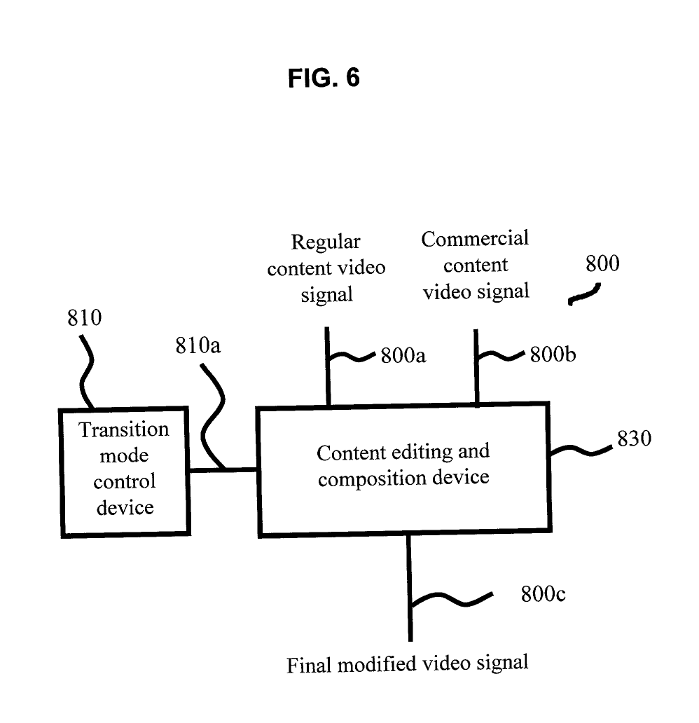

The first three embodiments according to the present invention as shown in FIGS. 1-3 deal with the situation when a video signal containing TV programs with both regular content portions (non-commercial) and commercial portions has already been created. The embodiments are therefore designed to find the easily detectable commercial transitions and replace them with modified commercial transitions that are undetectable or at least not easily detectable. However, when a video signal containing TV programs with both regular content portions and commercial portions has not been created, a fourth embodiment of the present invention as shown in FIG. 6 will be useful.

FIG. 6 shows a fourth embodiment in accordance with the present invention. FIG. 6 shows apparatus 800 that is comprised of a transition mode control device 810 and a content editing and composition device 830. Device 810 may be similar to device 710 of FIG. 5. The transition mode control device 810 is connected by a bus 810a to the content editing and composition device 830. Device 830 is connected to a bus 800a and to a bus 800b for receiving a regular content video signal and a commercial content video signal, respectively. Device 830 is also connected to a bus 800c for outputting a modified video signal wherein the modified video signal has special commercial transitions.

In operation, referring to FIG. 6, a regular content video signal and a commercial content video signal are input via the busses 800a and 800b, respectively, into the content editing and composition device 830. The content editing and composition device 830 may in general be used by human operators for editing and combining the regular content video signal with the commercial content video signal to form a video signal having both regular content and commercials. The transition mode control device 810 sends transition mode control signals to the content editing and composition device 830 via bus 810a. Device 810 sends selected transition modes and parameters with which special commercial transitions may be generated by the content editing and composition device 830. The special commercial transitions, which also can be called modified commercial transitions, are generated with the goal that they are undetectable. However, this goal implies that the transition mode control device 810 has sufficient knowledge about which transition modes with which parameters are most likely to produce the undetectable commercial transitions for commonly used automated commercial detection and elimination systems and methods. This may generally be achieved by a performance test with the following steps:

(a) The transition mode control device 810 selects a transition mode and a set of parameters and supplies them to the content editing and composition device 830 for generating a special or modified commercial transition.

(b) A first modified video signal with this first special or first modified commercial transition for separating the commercials within the first modified video signal is fed into a targeted automated commercial detection and elimination system.

(c) The steps in (a) and (b) are repeated for one or more further modified video signals having corresponding one or more further modified commercial transitions until the commercials within the particular modified video signal cannot be detected by the targeted automated commercial detection and elimination system. At that point the transition mode parameter and an associated set of parameters used to form the particular modified video signal and the identification for the targeted automated commercial detection and elimination system are stored into a table in computer memory

(d) Steps (a) through (c) can be repeated for all transition modes and for all targeted automated commercial detection and elimination systems.

(e) After step (d), the table in computer memory contains information about which transition modes with which set of parameters can generate modified commercial transitions that cannot be detected by which targeted automated commercial detection and elimination systems.

(f) The optimum transition modes with a certain set of parameters that can generate modified commercial transitions that cannot be detected by all or the majority of tested targeted automated commercial detection and elimination systems can be used.

(g) These optimum transition modes and any associated set of parameters can be stored in the transition mode control device 810 for generating the “undetectable” commercial transitions.

The performance test can also be done with following simplified steps:

(a) The transition mode control device 810 can select a transition mode and a set of parameters and supply them to the content editing and composition device 830 for generating a special or modified commercial transition.

(b) A first modified video signal with this special or first modified commercial transition for separating the commercials within the video signal is fed into all available targeted automated commercial detection and elimination systems.

(c) Steps (a) and (b) are repeated for a plurality of modified video signals having a corresponding plurality of modified commercials transitions until the commercials within a particular modified video signal cannot be detected by all of the targeted automated commercial detection and elimination system. At that point, the transition mode and any associated set of parameters are stored into a table in computer memory.

(d) Steps (a) through (c) can be repeated for all transition modes.

(e) The transition modes and the associated set of parameters can be extracted from the table in computer memory by the transition mode control device 810 for generating the “undetectable” modified commercial transitions.

Please note that the above-mentioned “undetectable” modified commercial transitions are only guaranteed to be undetectable for the tested targeted automated commercial detection and elimination system. In general, the “undetectable” modified commercial transitions may also be undetectable for other similar systems based on similar commercial detection principles. However, for a sure performance, it is recommended to include any automated commercial detection and elimination system in the targeted systems for a complete testing.

The above-mentioned test works well for any currently existing systems. However, if any automated commercial detection and elimination systems and methods improve their detection capabilities over time, with, for example, new detection methods and new software and hardware releases, the transition effect control device 810 may also need to update its stored transition mode parameters and other parameters for optimal effectiveness.

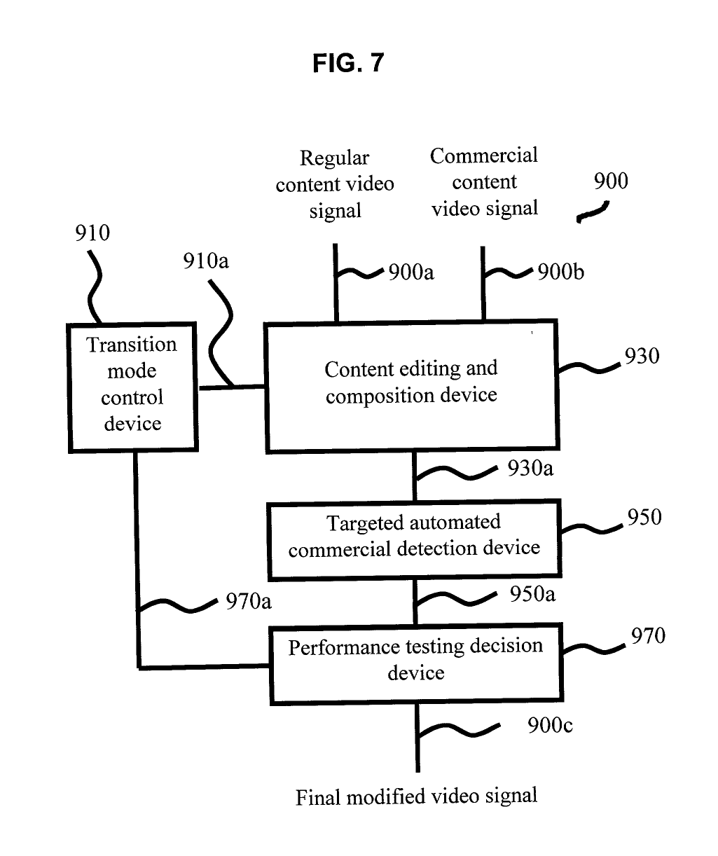

For obtaining an immediate response about the effectiveness of the system and method according to the present invention, a fifth embodiment in accordance with the present invention is shown in FIG. 7. FIG. 7 shows an apparatus 900 which is comprised of a transition mode control device 910, a content editing and composition device 930, a targeted automated commercial detection device 950, and a performance testing decision device 970. Devices 910 and 930 may be similar to devices 810 and 830 of FIG. 6. The transition mode control device 910 is connected by a bus 910a to the content editing and composition device 930. Device 930 is connected to busses 900a and 900b.

Device 930 also is connected to a bus 930a which is connected to the targeted automated commercial detection device 950. Device 950 has a bus 950a that is connected to the performance testing decision device 970. The performance testing decision device 970 is connected to an output bus 900c.

In operation the content editing and composition device 930 receives a regular content video signal via bus 900a and a commercial content video signal via bus 900b. The transition mode control device 910 supplies transition parameters to device 930 via bus 910a. Device 930 creates a video signal with commercial transitions from the signals on busses 900a and 900b. The transition parameters are used by the device 930 to change the video signal to a first modified video signal comprised of first modified commercial transitions. The first modified video signal is supplied to device 950 via bus 930a. The device 950 determines if the first modified commercial transitions can be detected. If the first modified commercial transitions can be detected a signal is sent via 950a through device 970, through bus 970a to the device 910 that another set of transition parameters needs to be selected.

In at least one embodiment, only when all the modified commercial transitions in the final modified video signal are no longer detectable by the targeted automated commercial detection device 950, device 970 will break the feedback loop and output the final modified video signal with proven undetectable commercial transitions at bus 900c. Otherwise the bus 950a is connected to the bus 970a and supplies results in a feedback loop to the transition mode control device 910. The targeted automated commercial detection device 950 as shown in FIG. 7 may contain actually a plurality of the automated commercial detection and elimination systems. The plurality of automated commercial detection systems can be run and tested in sequential or in parallel order. The testing results may contain all testing results from all of the automated commercial detection systems. The main advantage of this embodiment is its feedback capability that allows the entire system and method to effectively adapt to any changes or improvements with the automated commercial detection systems and methods.

A series of interim modified video signals (which include both regular content and commercial content) are supplied to the transition mode control device 910 via bus 970a during feedback operation.

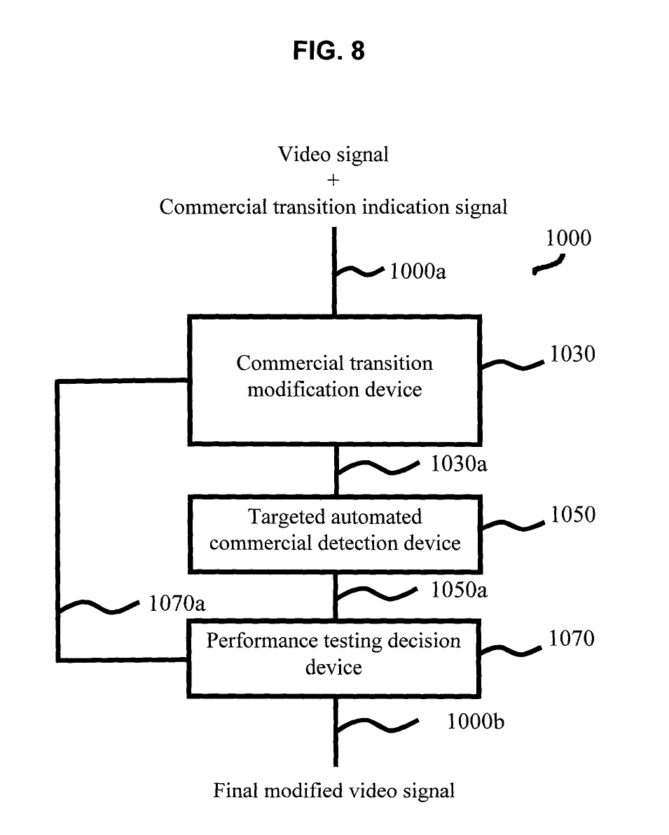

The same concept of the performance testing feedback loop implemented in the fifth embodiment of the invention shown in FIG. 7 may also be applied to the first three embodiments of the invention, as shown in FIG. 8. FIG. 8 shows an apparatus 1000 which is comprised of a commercial transition modification device 1030, a targeted automated commercial detection device 1050, and a performance testing decision device 1070. Device 1030 may be similar to devices 170, 270 and 370 as shown in FIGS. 1-3, respectively. Devices 1050 and 1070 may be similar to devices 950 and 970 of FIG. 7, respectively. The commercial transition modification device 1030 is connected by a bus 1030a to the targeted automated commercial detection device 1050. Device 1030 is connected to bus 1000a, for receiving a video signal and a commercial transition indication signal, similar to the busses 170a, 270a, and 370a of FIGS. 1-3, respectively. Device 1030 also is connected to a bus 1030a for outputting an interim modified video signal to the targeted automated commercial detection device 1050. Device 1050 supplies the automated commercial detection results via bus 1050a to performance testing decision device 1070. The performance testing decision device 1070 is connected back to the commercial transition modification device 1030 via a feedback bus 1070a. Device 1070 is also connected to a bus 1000b for outputting the final modified video signal with proven undetectable commercial transitions.

In operation, a first modified video signal on bus 1030a, which is similar to the buses 170b, 270b and 370b as shown in FIGS. 1-3, will be fed into a targeted automated commercial detection device 1050, similar to the device 950 in FIG. 7. The targeted automated commercial detection device 1050 tries to detect commercials from a first modified video signal. The commercial detection results are then fed into performance testing decision device 1070 similar to the device 970 shown in FIG. 7 that determines if the first modified commercial transitions in the first modified video signal are still detectable. If a modified commercial transition is still detectable, the performance testing decision device 1070 will send a first modified video signal back to the commercial transition modification device 1030 and request via a control signal a new modified commercial transition to be generated for replacing the detectable one and thus a new modified video signal. The control signal may indicate which transitions have been detected and therefore need to be modified. The commercial transition modification device 1030 will generate further modified commercial transitions based on the feedback signal and replace the detectable first modified commercial transitions with them. A second modified video signal with second modified commercial transitions will then be tested again. Only when all modified commercial transitions in a particular modified video signal are no longer detectable, the device 1070 will break the performance testing feedback loop and output the final modified video signal with the proven undetectable commercial transitions for broadcasting on bus 1000b.

I claim:

1. An apparatus comprising
a commercial transition modification device that replaces a plurality of commercial transitions in a video signal with a plurality of modified commercial transitions to form a modified video signal.

2. The apparatus of claim 1 further comprising
a commercial transition localization device that identifies the plurality of commercial transitions in the video signal and supplies data identifying the plurality of commercial transitions to the commercial transition modification device.

3. The apparatus of claim 1
wherein the plurality of commercial transitions includes transitions between commercial content portions of the video signal.

4. The apparatus of claim 1
wherein the plurality of commercial transitions include transitions between commercial content portions and non-commercial content portions of the video signal.

5. The apparatus of claim 1
wherein the plurality of modified commercial transitions cannot be detected by automated commercial detection.

6. The apparatus of claim 1 wherein
each of the plurality of commercial transitions of the video signal is comprised of a blank video frame; and
the commercial transition modification device removes a blank video frame from each of the plurality of commercial transitions to form the modified video signal.

7. The apparatus of claim 6 wherein
the commercial transition modification device removes a blank video frame from each of the plurality of commercial transitions and inserts a non-blank video frame into each of the plurality of commercial transitions.

8. The apparatus of claim 1 wherein
each of the plurality of commercial transitions of the video signal include a dark video frame; and
the commercial transition modification device removes a dark video frame from each of the plurality of commercial transitions to form the modified video signal.

9. The apparatus of claim 8 wherein
the commercial transition modification device removes a dark video frame from each of the plurality of commercial transitions and inserts a non-dark video frame into each of the plurality of commercial transitions.

10. The apparatus of claim 1 wherein
each of the plurality of modified commercial transitions corresponds to one of the plurality of commercial transitions;
each of the plurality of commercial transitions contains a set of a first number of video frames;
each of the plurality of modified commercial transitions contains a set of the first number of video frames.

11. The apparatus of claim 1 wherein
each of the plurality of modified commercial transitions corresponds to one of the plurality of commercial transitions;
each of the plurality of commercial transitions contains a set of a first number of video frames;
each of the plurality of modified commercial transitions contains a set of a second number of video frames;
wherein the first number and the second number are different.

12. The apparatus of claim 1 further wherein
each of the plurality of modified commercial transitions is comprised of a content-dependent transition video frame.

13. The apparatus of claim 12 wherein
each of the content-dependent transition video frames are generated by using video frames that are not blank or dark and are located immediately before and after a commercial transition.

14. The apparatus of claim 1 wherein
each of the plurality of modified commercial transitions is comprised of a semi-content-dependent transition video frame.

15. The apparatus of claim 14 wherein
each semi-content-dependent transition video frame is generated by using video frames that are not blank or dark and located immediately before and after a commercial transition.

16. The apparatus of claim 15 wherein
each semi-content-dependent transition video frame offers a transition from a video scene before a commercial transition through a foreign video scene that is in general not related to a video scene before a commercial transition or a video scene after a commercial transition and to the video scene after a commercial transition; and wherein
the said foreign video scene is in general not blank or dark.

17. The apparatus of claim 1 further wherein
each of the plurality of modified commercial transitions are comprised of a content-independent transition video frame that is not blank or dark.

18. The apparatus of claim 17 wherein
each of the plurality of modified commercial transitions are independent from the video frames immediately before and after a commercial transition.

19. A method comprising
replacing a plurality of commercial transitions in a video signal with a plurality of modified commercial transitions to form a modified video signal.

20. The method of claim 19 further comprising
identifying the plurality of commercial transitions in the video signal.

21. The method of claim 19 wherein
the plurality of commercial transitions includes transitions between commercial content portions of the video signal.

22. The method of claim 19 wherein
the plurality of commercial transitions include transitions between commercial content portions and non-commercial content portions of the video signal.

23. The method of claim 19 wherein
the plurality of modified commercial transitions cannot be detected by automated commercial detection.

24. The method of claim 19 wherein
each of the plurality of commercial transitions of the video signal is comprised of a blank video frame; and further comprising
removing a blank video frame from each of the plurality of commercial transitions to form the modified video signal.

25. The method of claim 24 further comprising
inserting a non-blank video frame into each of the plurality of commercial transitions.

26. The method of claim 19 wherein
each of the plurality of commercial transitions of the video signal include a dark video frame; and further comprising
removing a dark video frame from each of the plurality of commercial transitions to form the modified video signal.

27. The method of claim 26 wherein
inserting a non-dark video frame into each of the plurality of commercial transitions.

28. The method of claim 19 wherein
each of the plurality of modified commercial transitions corresponds to one of the plurality of commercial transitions;
each of the plurality of commercial transitions contains a set of a first number of video frames;
each of the plurality of modified commercial transitions contains a set of the first number of video frames.

29. The method of claim 19 wherein
each of the plurality of modified commercial transitions corresponds to one of the plurality of commercial transitions;
each of the plurality of commercial transitions contains a set of a first number of video frames;
each of the plurality of modified commercial transitions contains a set of a second number of video frames;
wherein the first number and the second number are different.

30. The method of claim 19 wherein
each of the plurality of modified commercial transitions is comprised of a content-dependent transition video frame.

31. The method of claim 30 wherein
each of the content-dependent transition video frames are generated by using video frames that are not blank or dark and are located immediately before and after a commercial transition.

32. The method of claim 19 wherein
each of the plurality of modified commercial transitions is comprised of a semi-content-dependent transition video frame.

33. The method of claim 32 wherein
each semi-content-dependent transition video frame is generated by using video frames that are not blank or dark and located immediately before and after a commercial transition.

34. The method of claim 33 wherein
each semi-content-dependent transition video frame offers a transition from a video scene before a commercial transition through a foreign video scene that is in general not related to a video scene before a commercial transition or a video scene after a commercial transition and to the video scene after a commercial transition; and wherein
the said foreign video scene is in general not blank or dark.

35. The method of claim 19 wherein
each of the plurality of modified commercial transitions are comprised of a content-independent transition video frame that is not blank or dark.

36. The method of claim 35 wherein
each of the plurality of modified commercial transitions are independent from the video frames immediately before and after a commercial transition.

37. The apparatus of claim 1 further comprising
a targeted automated commercial detection device that tests if a first modified commercial transition of the plurality of modified commercial transitions is undetectable

38. The apparatus of claim 37 wherein
the targeted automated commercial detection device tests if all of the modified commercial transitions in the plurality of modified commercial transitions are undetectable.

39. The method of claim 19 and further comprising
determining if a first modified commercial transition of the plurality of modified commercial transitions is undetectable for a given plurality of automated commercial detection and elimination systems.

40 The method of claim 39 further comprising
determining if all of the modified commercial transitions in the plurality of modified commercial transitions are undetectable for a given plurality of automated commercial detection and elimination systems.

41. A method comprising the steps of
selecting a first set of parameters;
using the first set of parameters to form a first modified video signal comprised of a first modified commercial transition, said first modified video signal derived from a video signal comprised of a commercial transition;
determining if a commercial detection device can detect the first modified commercial transition; and
if the commercial detection device can detect the first modified commercial transition, selecting a second set of parameters and using the second set of parameters to form a second modified video signal comprised of a second modified commercial transition, said second modified video signal derived from the video signal comprised of the commercial transition.

42. The method of claim 41 wherein
the steps of
selecting a set of parameters;
using the set of parameters to form a modified video signal comprised of a modified commercial transition, said modified video signal derived from the video signal comprised of the commercial transition;
and determining if a commercial detection device can detect a modified commercial transition;
are repeated for a plurality of sets of parameters, a plurality of modified commercial transitions, and a plurality of modified video signals, until the commercial detection device can not detect a modified commercial transition.

43 The method of claim 42 wherein
when the commercial detection device can not detect a modified commercial transition, the set of parameters used to form the modified commercial transition which could not be detected, are stored in a computer memory.

44. An apparatus comprising
a commercial detection device;
a transition mode control device;
wherein the transition mode control device selects a first set of parameters which are used to form a first modified video signal comprised of a first modified commercial transition, said first modified video signal derived from a video signal comprised of a commercial transition;
wherein the commercial detection device determines if it can detect the first modified commercial transition; and
if the commercial detection device can detect the first modified commercial transition, the transition mode control device selects a second set of parameters and uses the second set of parameters to form a second modified video signal comprised of a second modified commercial transition, said second modified video signal derived from the video signal comprised of the commercial transition.

45. The apparatus of claim 44 wherein
the transition mode control device repeats the steps of selecting a set of parameters, using the set of parameters to form a modified video signal comprised of a modified commercial transition, said modified video signal derived from the video signal comprised of the commercial transition;.
and the commercial detection device repeats the step of determining if a commercial detection device can detect a modified commercial transition;
for a plurality of sets of parameters, a plurality of modified commercial transitions, and a plurality of modified video signals, until the commercial detection device can not detect a modified commercial transition.

46 The apparatus of claim 45 further comprised of
a computer memory;
and wherein when the commercial detection device can not detect a modified commercial transition, the set of parameters used to form the modified commercial transition which could not be detected, are stored in the computer memory.
